(19) United States
(12) Patent Application Publication
(10) Pub. No.: US 2009/0282651 A1
(43) Pub. Date: Nov. 19, 2009

(54) Door handle for elbow or arm operation

(76) Inventor: Ue-Ming Yang, Moraga, CA (US)

Correspondence Address: UE-MING YANG, 2712 S. UNION AVE., CHICAGO, IL, 60616, US

(21) Appl. No.: 12/152,897

(22) Filed: May 19, 2008

(51) Int. Cl. E05B 1/00

(52) U.S. Cl. 16/412

(57) ABSTRACT

A door handle is capable of rotating along its longitudinal axis from a first stop to a second stop with a person's elbow or arm pushing force. At the second stop, the door handle provides an accessible elbow/arm landing area so that the person can continuously exert elbow/arm pushing force on the door handle in the direction of about 45 degree apart from the door surface, and thus generate a torque for opening the door without using a hand. There is a self closing means for self returning the door handle from second stop to first stop upon releasing elbow/arm pushing force. The door handle is normally retained at first stop by a biases spring force.

### BACKGROUND OF INVENTION

This invention relates to a door handle, particularly, a refrigerator door handle or the like.

The most frequently used door in a household is probably a refrigerator door. Regardless of various types of door handles being disclosed in prior art, all door handles are intent to be operated by hand. Occasionally, user may need to open the refrigerator door while both hands are occupied or not suitable for gripping the door handle. For example, user may need to carry a heavy or large object with both hands for storage in a refrigerator. In this situation, user needs to open the door without carrying the object first, leave the door widely open, and then walk back and forth between the refrigerator and other location to retrieve the object and carry it to the refrigerator. This is not convenient, Also, keeping refrigerator widely open for long period of time is certainly not desirable. For another example, during food preparation, user may need to frequently visit refrigerator when both hands are not cleaned. In this situation, the handle will be certainly “contaminated” by hand contact. Up to today, there does not exist a prior art that has properly addressed or solved the above problem.

One possible approach to the above problem is to adopt a manual door opening device exclusively operated by foot. However, the complexity and cost of the device do not justify this approach.

Another possible approach to the above problem is to adopt an automatic door opening device. But this approach does not truly solve the problem because user still needs to apply hand during door operation. Again, the complexity and cost of the device do not justify this approach.

Therefore, there is a need to find a simple and economical approach to the above problem. The approach of present invention is to provide a novel door handle that allows user to open the refrigerator door not only by hand, but also by arm or elbow. A typical door handle of prior art is illustrated in FIG. 1. The handle is located near the opening side of door with a clearance X from the door surface. The clearance X allows user to grip onto the handle by hand. The top end of handle is fixedly fastened to an anchor plate which is fixedly fastened to the top edge of the door. The bottom end of door handle is fixedly fastened to the internal frame structure of the door (not shown). It is necessary to keep clearance X at minimum in order to minimize the occupying volume of refrigerator during transportation, and maximize the trafficking space before the refrigerator. From a safety standpoint of view, clearance X shall not allow a person's hand, elbow or arm to pass through. As restricted by the minimum clearance X, user can only push the handle with elbow or arm in a direction parallel to door surface. Therefore, it does not create a torque for opening the door.

According to present invention, the novel door handle is capable of rotating about its longitudinal axis between two angular stop positions with a self closing means. At the first stop position, the door handle is at minimum clearance to door surface so that user can not possibly open the door with elbow or arm as previously discussed in prior art above. However, user can rotate the door handle from first stop position to second stop position with elbow or arm. At the second stop position, the door handle provides an accessible elbow/arm landing area that allows user to exert an elbow/arm pushing force on the door handle in the direction of about 45 degree apart from the door surface, and thus generate a torque for opening the door. The self closing means of door handle allows the door handle to self return from second stop position to first stop position upon releasing elbow/arm pushing force, so that the door handle is normally retained at first stop position with minimum clearance to door surface by a biases spring force.

One distinctive feature of present invention is that the elbow/arm landing area in door handle is in a vertical plan intersecting the door surface at about 45 degree facing either opening side or hinged side of the door. This allows user to exert elbow/arm pushing force upon the elbow/arm landing area to generate maximum torque for opening the door. This also allows door handle of present invention for use in side-by-side doors, which has a minimum clearance in between.

### SUMMARY OF THE INVENTION

One object of present invention is to provide a door handle operable not only by hand, but also by elbow or arm.

Another object of present invention is to provide such a door handle for use in adjacent top and bottom doors.

Another object of present invention is to provide such a door handle for use in adjacent left and right doors.

Another object of present invention is to provide such a door handle at minimum clearance to the front surface of the door.

### BRIEF DISCUSSION OF THE DRAWINGS

FIG. 1 shows a perspective view of a typical door handle of prior art.

FIG. 2A shows the perspective view of the first preferred embodiments of the door handle of present invention.

FIG. 2B shows the exploded and cross sectional views of the first preferred embodiments of the door handle of present invention.

FIG. 3 shows the perspective view of the second preferred embodiments of the door handle of present invention.

FIG. 4 shows the perspective view of the third and fourth preferred embodiments of the door handles of present invention.

### DETAILED DISCUSSIONS OF THE DRAWINGS

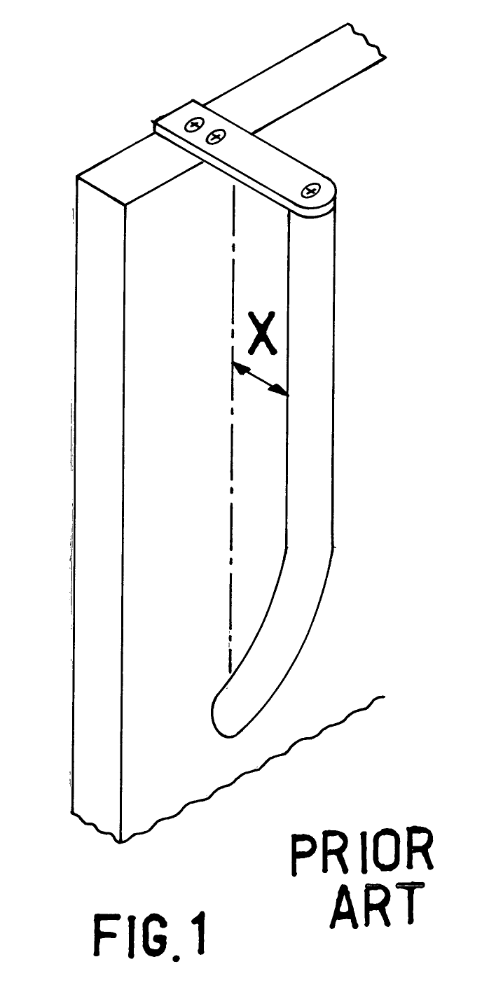

FIG. 1 shows a perspective view of a typical door handle of prior art for a right hand refrigerator door. The handle is located at a clearance X from the door surface. The top end of handle is fixedly fastened to an anchor plate which is fixedly fastened to the top edge of the door. The bottom end of door handle is fixedly fastened to an internal frame structure of the door (not shown) with concealed fasteners for enhancing the appearance of the refrigerator. As restricted by the minimum clearance X, user can only push the handle with elbow or arm in a direction parallel to door surface. Therefore, it does not create a torque for opening the door.

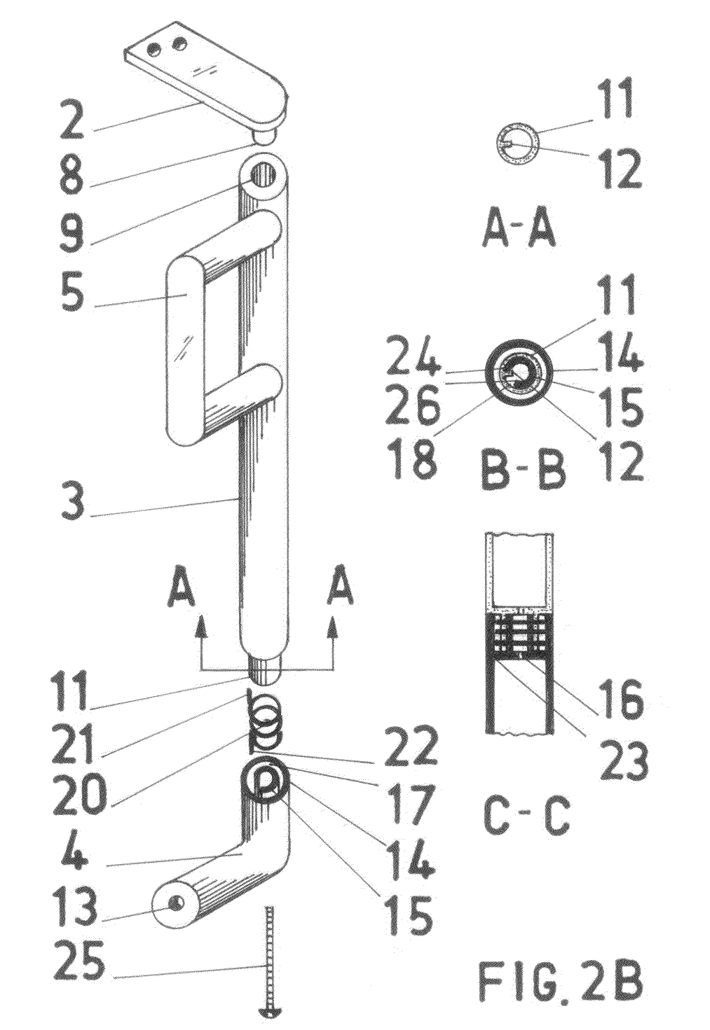

FIG. 2A and FIG. 2B show the perspective, exploded and cross sectional views of the first preferred embodiments of the door handle of present invention. The door handle 1 comprises of an anchor plate 2, a first bar handle 3, an anchor bracket 4 and a second bar handle 5. Anchor plate 2 is fixedly connected to a top edge 6 of door 7 by a pair of fasteners without a possibility of swiveling. In FIG. 2B, a stud 8 is provided at the bottom side of anchor plate 2 that engages with a center hole 9 at the top end of bar handle 3 to form a first rotational joint 10. Second bar handle 5 has a pair of integral legs fixedly connected to bar handle 3, so that second bar handle 5 is positioned in parallel to first bar handle 3 at a minimum distance. Preferably, second bar handles 5 is constructed as an integral part of first bar handle 3. The bottom end of bar handle 3 is constructed of a reduced-size pipe end 11 that has a projectile 12 projected radially inward. The anchor bracket 4 is in a general form of a long-radius elbow, and is referred as an elbow bracket 4 hereinafter. The bottom or vertical end of elbow bracket 4 is provided with a through hole 13 for engaging with an anchoring device (not shown) so that elbow bracket 4 is fixedly connected to an internal frame (not shown) of door 7. The top or horizontal end of elbow bracket 4 is constructed of concentric outer pipe end 14 and inner pipe end 15, which are integrally connected to a bottom sealed plate 16. An annular cavity 17 is formed between outer and inner pipe ends 14 and 15. A rectangular cut off opening 18 is provided in inner pipe end 15 in axial direction, which corresponds to an about 45 degree angular opening in inner pipe end 15.

The top end elbow bracket 4 and the bottom end of bar handle 3 can be easily assembled to form a rotational joint 19 with a self closing means. First, a torsion spring 20 is placed over the outer surface of pipe end 11. The top end 21 of torsion spring 20 being fixed connected to pipe end 11 (not shown). The bottom end 22 of torsion spring 20 is strategically located so that it offsets projectile 12 by (say) ¼ turn (90 degree) in the angular direction from bottom end 22 to projectile 12 clockwise. It should be noted that, for clarity reason, torsion spring 20 is omitted from cross sectional view B-B in FIG. 2B. Second, a hole 23 is provided in sealed plated 16 for receiving the bottom end 22 of torsion spring 20. Hole 23 is strategically located in sealed plate 16 in line with the rear end 24 of cutoff opening 18. The bottom end 22 of torsion spring 20 is partially inserted into hole 23. In such configuration, projectile 12 is offset from cutoff opening 18 so that inner pipe end 15 of elbow bracket 4 can not be possibly inserted into pipe end 11 of bar handle 3. Third, simultaneously rotate elbow bracket 4 at least ¼ turn counter clockwise (to position projectile 12 in line with cutoff opening 18) and insert inner pipe end 15 of elbow bracket 4 into pipe end 11 of bar handle 3. As a result, projectile 12 is retained by the rear end 24 of cutoff opening 18 by torsion spring 20, which forms a first stop position of bar handle 3. After completion, a fastener 25 is inserted into elbow bracket 4 which tightens elbow bracket 4 and bar handle 3 together to form the second rotational joint 19 with a self closing means.

A front end 26 of cutoff opening 18 is provided at about 45 degree apart from the rear end 24 of cut off opening 18, which forms a second stop position of bar handle 3. As a result, door handle 1 of present invention operates as follows:

1. Bar handles 3 and 5 are normally retained by a spring biases force at a first angular stop, where they form a vertical plan in parallel to the front surface of door 7.
2. Bar handles 3 and 5 are at a second angular stop, where they form a vertical plan that intersects the front surface of door 7 at about 45 degree angle.
3. Bar handles 3 and 5 are capable of being rotated from first angular stop to second angular stop when an user exerts an elbow/arm pushing force upon second bar handle with elbow/arm.
4. Bar handle 5 provides an accessible elbow/arm landing area at second angular stop position that allows user to continuously exert elbow/arm pushing force upon second bar handle in a direction of about 45 degree apart from the front surface of door 7, and thus generate a torque for opening door 7.
5. Bar handles 3 and 5 are capable of self returning from second angular stop to first angular stop upon releasing of the elbow/arm pushing force.

It is under stood that bar handle 5 can be located at right or left side of bar handle 3 without affecting operability of door handle 1. Preferably, bar handle 5 is located to the left side of bar handle 3, i.e. between first bar handle 3 and the opening side 27 of door 7. This allows user to open door 7 with right elbow or arm. It becomes apparent that, if bar handle 5 is located to the right side of bar handle 3, user needs to open door 7 with left elbow or arm.

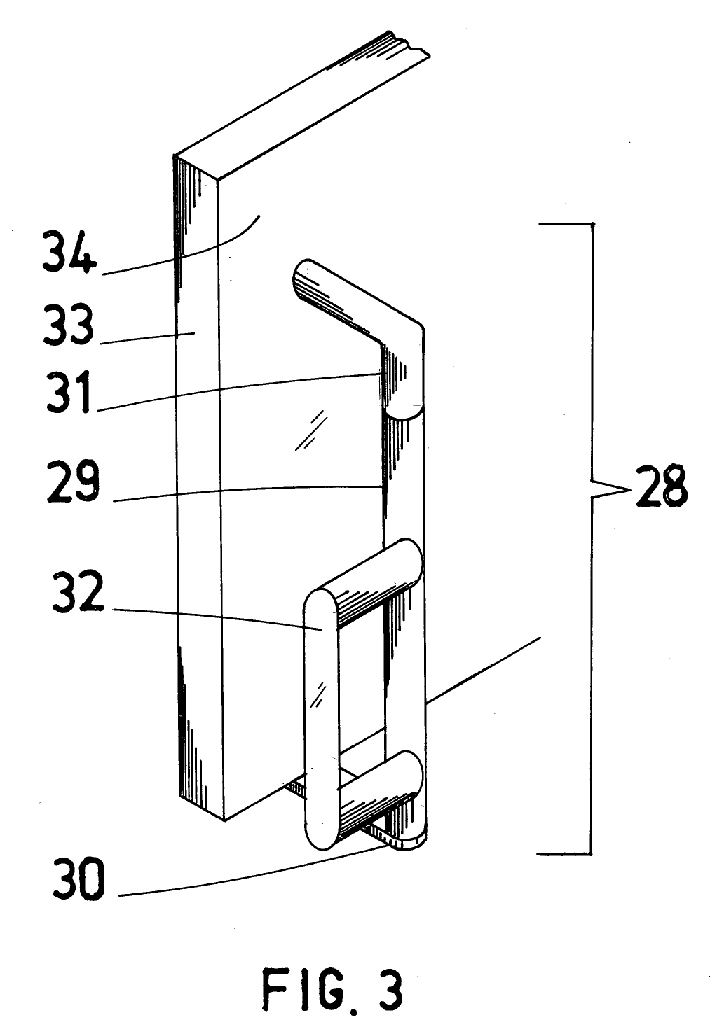

FIG. 3 shows the perspective view of the second preferred embodiments of the door handle of present invention. The first and second preferred embodiments represent the door handle for use in a pair of adjacent bottom and top doors respectively. In FIG. 3, door handle 28 comprises of a first bar handle 29, an anchor plate 30, an anchor bracket 31 and a second bar handle 32. Door handle 28 is considered as an up-side-down installation of door handle 1 of first preferred embodiments, with second bar handle 32 being located between first bar handle 29 and the opening side 33 of door 34. Therefore, author of present invention does not intend to provide further detailed discussions for door handle 28.

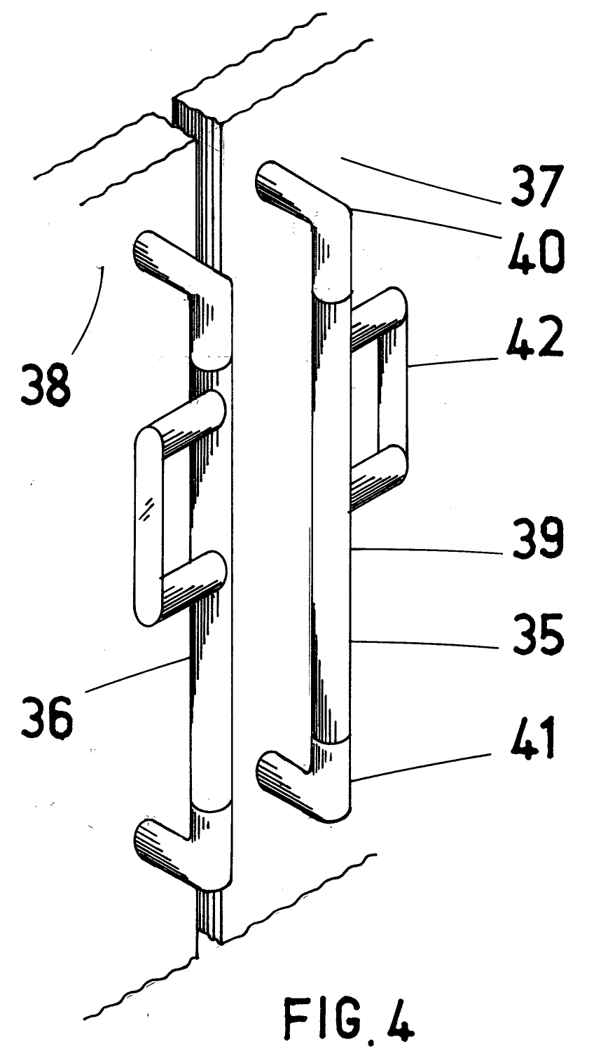

FIG. 4 shows the perspective view of the third and fourth preferred embodiments of the door handles of present invention. In FIG. 4, door handles 35 and 36 represent the third and fourth preferred embodiments of present invention for use in a pair of adjacent side-by-side doors 37 and 38 respectively. Door handle 35 comprises of a first bar handle 39, an upper anchor bracket 40, a lower anchor bracket 41 and a second bar handle 42. Door handle 35 is identical to door handle 1 of first preferred embodiments, with two exceptions. In first exception, anchor plate 2 of first preferred embodiments is now replaced by anchor bracket 40. Anchor brackets 40 and 41 are fixedly connected to door 7 in the same manner as anchor bracket 4 in the first preferred embodiments. However, anchor bracket 40 is pivotally connected to the first bar handle 39 in the same manner as anchor plate 2 in the first preferred embodiments. In second exception, second bar handle 42 in third preferred embodiments is located to the right side of first bar handle 39. In the first preferred embodiments, second bar handle 5 is preferably located to the left side of first bar handle 3. This is due to the fact that side-by-side door handles 35 and 36 is typically provided with minimum clearance in between. Such minimum clearance is not sufficient to provide an elbow/arm landing area. As previously discussed, the second bar handle can be located at either side of first bar handle without affecting operability of door handle 35. As a result, user may need to push second bar handle 42 with left elbow or arm in order to open the door. In the fourth preferred embodiments, door handle 36 is considered as a mirror image of door handle 35 in the third preferred embodiments. Therefore, author of present invention does not intend to provide further detailed discussions for door handles 35 and 36.

It is understood that some modifications and variations to the above preferred embodiments are allowed within the scope of present invention. For example, the type of anchor bracket, the configuration of second bar handle, the means of connecting second bar handle to first bar handle, or the means of anchoring the anchor bracket to the door surface can be varied without exceeding the scope of present invention. The self closing means for the second bar handle can be modified so that a compression or tension spring can be adopted in lieu of torsion spring. Such modifications and variations shall be considered within the scope of present invention.

What is claimed is:

1. A door handle for use in a top and bottom doors comprising of:
a anchor plate, and a means of fixedly connecting said anchor plate to a bottom and top edges of said top and bottom doors respectively without a possibility of a swiveling movement of said anchor plate,
a anchor bracket, and a means of fixedly connecting said anchor bracket to an internal frame behind a door surface without a possibility of a swiveling movement of said anchor bracket,
a elongated first bar handle having a top and bottom ends, and a means of pivotally connecting said top and bottom ends of said first bar handle to said anchor plate and said anchor bracket respectively in said bottom door, pivotally connecting said top and bottom ends of said first bar handle to said anchor bracket and said anchor plate respectively in said top door, so that said first bar handle is positioned vertically in parallel to said door surface with a first clearance between said first bar handle and said door surface, and said first bar handle is capable of rotating about its longitudinal axis between a first and second angular stops,
a second bar handle, and a means of fixedly connecting said second bar handle to said first bar handle, so that said second bar handle is positioned vertically in parallel to said first bar handle with a second clearance between said first and second bar handles;
wherein:
said first and second clearances allow an user to grip onto said first and second bar handles individually by hand; and
said first and second bar handles are capable of rotating about the longitudinal axis of said first bar handle between said first and second angular stops with a self closing means, in which:
said first and second bar handles are normally retained by a spring biases force at said first angular stop, where said first and second bar handles form a first vertical plan in parallel to said door surface; and
said first and second bar handles are at said second angular stop, where said first and second bar handles form a second vertical plan that intersects said door surface at about 45 degree angle; and
said first and second bar handles are capable of being rotated from said first angular stop to said second angular stop when an user exerts an elbow/arm pushing force upon said second bar handle with elbow/arm; and
said second bar handle provides an accessible elbow/arm landing area at said second angular stop that allows said user to continuously exert said elbow/arm pushing force upon said second bar handle in a direction of about 45 degree apart from said door surface, and thus generate a torque for opening said door; and
said first and second bar handles are capable of self returning from said second angular stop to said first angular stop upon releasing of said elbow/arm pushing force.

2. A door handle for use in a right and left doors comprising of:
a upper and lower anchor brackets, and a means of fixedly connecting said upper and lower anchor brackets to an internal frame behind a door surface without a possibility of a swiveling movement of said upper and lower anchor brackets,
a elongated first bar handle having a top and bottom ends, and a means of pivotally connecting said top and bottom ends of said first bar handle to said upper and lower anchor brackets respectively, so that said first bar handle is positioned vertically in parallel to said door surface with a first clearance between said first bar handle and said door surface, and said first bar handle is capable of rotating about its longitudinal axis between a first and second angular stops,
a second bar handle, and a means of fixedly connecting said second bar handle to said first bar handle, so that said second bar handle is positioned vertically to the right and left sides of said first bar handle in said right and left doors respectively, and in parallel to said first bar handle with a second clearance between said first and second bar handles;
wherein:
said first and second clearances allow an user to grip onto said first and second bar handles individually by hand; and
said first and second bar handles are capable of rotating about the longitudinal axis of said first bar handle between said first and second angular stops with a self closing means, in which:
said first and second bar handles are normally retained by a spring biases force at said first angular stop, where said first and second bar handles form a first vertical plan in parallel to said door surface; and
said first and second bar handles are at said second angular stop, where said first and second bar handles form a second vertical plan that intersects said door surface at about 45 degree angle; and
said first and second bar handles are capable of being rotated from said first angular stop to said second angular stop when an user exerts an elbow/arm pushing force upon said second bar handle with elbow/arm; and
said second bar handle provides an accessible elbow/arm landing area at said second angular stop that allows said user to continuously exert said elbow/arm pushing force upon said second bar handle in a direction of about 45 degree apart from the door surface, and thus generate a torque for opening said door; and
said first and second bar handles are capable of self returning from said second angular stop to said first angular stop upon releasing of said elbow/arm pushing force.

3. In claim 1, said second bar handle is positioned vertically between said first bar handle and an opening side of said top and bottom doors.

4. In claim 2, at least one of the top and bottom ends of said first bar handle is pivotally connected to said anchor bracket to form a rotational joint, which is provided with said first and second angular stops, and a torsion spring for self returning said first bar handle from said second angular stop to said first angular stop.

5. In claims 1 and 2, said second bar handle is constructed as an integral part of said first bar handle.

6. In claims 1 and 2, said anchor bracket is in a general form of a long radius elbow in various degrees.
